(19) United States
(12) Patent Application Publication
(10) Pub. No.: US 2019/0012743 A1
(43) Pub. Date: Jan. 10, 2019

(54) SYSTEM TO SUPPORT SUPPLEMENTAL RISK RELATIONSHIP REQUESTS VIA AGENCY MANAGEMENT SYSTEM COMPUTER SERVER

(71) Applicants: Donna Kinney Resutek, Ellington, CT (US); Lisa Dawkins Snyder, Charlotte, NC (US)

(72) Inventors: Donna Kinney Resutek, Ellington, CT (US); Lisa Dawkins Snyder, Charlotte, NC (US)

(21) Appl. No.: 15/645,108

(22) Filed: Jul. 10, 2017

(51) Int. Cl. G06Q 40/08; G06Q 10/10

(52) U.S. Cl. CPC G06Q 40/08; G06Q 10/10

(57) ABSTRACT

A risk relationship agency management system computer server may access information in a potential risk relationship data store. Based on indications associated with potential risk relationship categories and an entity description, it may be determined that a supplemental potential risk relationship can be offered to a potential risk relationship entity, and, as a result, a graphical request symbol may be displayed. Upon selection of the request symbol, the system may create an electronic quote request that includes a potential risk relationship entity identifier, a remote risk relationship agent device identifier, and the entity description. A servicing entity computer server may then arrange to match the potential risk relationship entity with a selected supplemental potential risk relationship provider.

### BACKGROUND

A customer may be potentially interested in entering into a risk relationship with an enterprise. For example, a business might be potentially interested in purchasing insurance from an insurer (e.g., to help spread risks associated with property damage, worker injuries, etc.). When exploring such a potential relationship, the business typically provides various types of information to the insurer (e.g., what type of business it is, how long the business has existed, how many employees work for the business, etc.) and receives an insurance quote, including an estimated insurance premium value, from the insurer. The business can then decide whether or not it will purchase an insurance policy from the insurer.

Note that in the United States, an “admitted” insurance company that has received a license from a state department of insurance authorizing it to write specific lines of insurance (e.g., workers' compensation, property and liability, etc.). Admitted insurance companies may be bound by rate and form regulations, and are regulated to protect policy holders. In some cases, however, admitted insurance companies may not be interested in providing a particular type of insurance. This might be because, by ways of example only, a party is a new entity that does not have an adequate loss history, a party is associated with unusual risk characteristics, a policy has atypical coverages or deductibles, etc. In such situations, a non-admitted insurance enterprise may be allowed to furnish a supplemental risk relationship. For example, the insurance enterprise might offer the customer what is referred to as “excess and surplus” insurance. The tasks required by an insurance agent to gather the information needed to have such an insurance policy underwritten can be a time-consuming and error prone task (and may be duplicative of the efforts required by the insurance agent and/or potential customer to obtain another insurance policy from an admitted insurance company).

It would therefore be desirable to provide systems and methods to facilitate the offering of a supplemental risk relationship to an entity in an automated, efficient, and accurate manner.

### SUMMARY OF THE INVENTION

According to some embodiments, systems, methods, apparatus, computer program code and means are provided to facilitate the offering of a supplemental risk relationship to an entity in an automated, efficient, and accurate manner. In some embodiments, risk relationship agency management system computer server may access information in a potential risk relationship data store. Based on indications associated with potential risk relationship categories and an entity description, it may be determined that a supplemental potential risk relationship can be offered to a potential risk relationship entity, and, as a result, a graphical request symbol may be displayed. Upon selection of the request symbol, the system may create an electronic quote request that includes a potential risk relationship entity identifier, a remote risk relationship agent device identifier, and the entity description. A servicing entity computer server may then arrange to match the potential risk relationship entity with a selected supplemental potential risk relationship provider.

Some embodiments comprise: means for accessing, by a computer processor of a risk relationship agency management system computer server, a potential risk relationship data store including a plurality of electronic records each including a potential risk relationship entity identifier, a remote risk relationship agent device identifier, indications associated with potential risk relationship categories, and an entity description; based on the indications associated with the potential risk relationship categories and the entity description, means for dynamically determining, by the computer processor of the risk relationship agency management system computer server, that a supplemental potential risk relationship can be offered to the potential risk relationship entity; means for exchanging information via a distributed communication network with a remote risk relationship agent device associated with the remote risk relationship agent device identifier to arrange for a graphical request symbol to be displayed; means for receiving from the remote risk relationship agent device an indication that the graphical request symbol has been selected; responsive to the selection, means for automatically creating, by the computer processor of the risk relationship agency management system computer server, an electronic quote request that includes the potential risk relationship entity identifier, the remote risk relationship agent device identifier, and the entity description; means for transmitting the electronic quote request to a servicing agency entity computer server; responsive to the quote request, means for arranging, by a computer processor of the servicing agency entity computer server, to match the potential risk relationship entity with a selected one of a plurality of supplemental potential risk relationship providers; and means for transmitting an indication of the selected supplemental potential risk relationship provider from the servicing agency entity computer server to the risk relationship agency management system computer server.

In some embodiments, a communication interface associated with a back-end application computer server exchanges information with remote front-end user devices. The information may be exchanged, for example, via public and/or proprietary communication networks.

Technical effects of some embodiments of the invention are improved and computerized ways to facilitate the offering of a supplemental risk relationship to an entity in an automated, efficient, and accurate manner. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is a high-level block diagram of a system according to some embodiments.

FIG. 2 illustrates a method according to some embodiments of the present invention.

FIG. 3 is an electronic business center home page display in accordance with some embodiments.

FIG. 4 is an account management display to add a new customer according to some embodiments of the present invention.

FIG. 5 is new customer display in accordance with some embodiments.

FIG. 6 is a customer classification display according to some embodiments of the present invention.

FIG. 7 is a new line of business display in accordance with some embodiments.

FIG. 8 is an excess and surplus lines quote request display according to some embodiments of the present invention.

FIG. 9 is an excess and surplus quote request acknowledgement display in accordance with some embodiments.

FIG. 10 is a quote request details display according to some embodiments of the present invention.

FIG. 11 is a detailed block diagram of a system according to some embodiments.

FIG. 12 is a block diagram of a platform in accordance with some embodiments of the present invention.

FIG. 13 is a portion of a potential risk relationship database in accordance with some embodiments.

FIG. 14 is a portion of a request database in accordance with some embodiments.

FIG. 15 is a portion of a supplemental risk relationship database in accordance with some embodiments.

FIG. 16 illustrates a servicing entity method according to some embodiments.

FIG. 17 illustrates a handheld tablet device displaying new line of business display according to some embodiments.

FIG. 18 illustrates an overall insurance enterprise workflow in accordance with some embodiments.

### DETAILED DESCRIPTION

The present invention provides significant technical improvements to facilitate electronic messaging and dynamic data processing. The present invention is directed to more than merely a computer implementation of a routine or conventional activity previously known in the industry as it significantly advances the technical efficiency, access, and/or accuracy of communications between devices by implementing a specific new method and system as defined herein. The present invention is a specific advancement in the area of information processing by providing benefits in data accuracy, data availability, and data integrity and such advances are not merely a longstanding commercial practice. The present invention provides improvement beyond a mere generic computer implementation as it involves the processing and conversion of significant amounts of data in a new beneficial manner as well as the interaction of a variety of specialized client and/or third party systems, networks, and subsystems. For example, in the present invention may exchange information between a risk relationship agency management system computer server and a servicing entity computer server in an automated and efficient manner, thus improving the overall performance of the system associated with an enterprise (e.g., by avoiding the need for duplicate data entry and reducing errors). Moreover, embodiments associated with automatic determinations of supplemental insurance offerings might further improve communication network performance, user interactions (e.g., by increasing the accuracy of excess and surplus insurance business obtained via a servicing entity), etc. Moreover, embodiments may improve user communications for an enterprise by coordinating messages from an agency management system and/or agent device to a remote servicing entity computer server (e.g., by automatically supplying a correct communication address to the agency management system, agent device, and/or the servicing entity computer server).

A user may be interested in establishing a risk relationship with an enterprise. For example, a business might want to purchase property and liability insurance, workers' compensation insurance, etc. from an admitted insurer. When deciding whether or not to enter into such a relationship, the business will typically provide information describing the business to the insurer and receive an insurance quote, including an estimated insurance premium value, from the insurer. Often, the business will interact with an insurance agent (who has substantial experience collecting information about businesses) to provide these details to the insurer. In some cases, a potential customer may be required to purchase a supplemental risk relationship from a non-admitted insurance company (e.g., excess and surplus insurance). Gathering the information needed to obtain such insurance, however, can be a time consuming and error-prone task for the insurance agent and/or the potential customer.

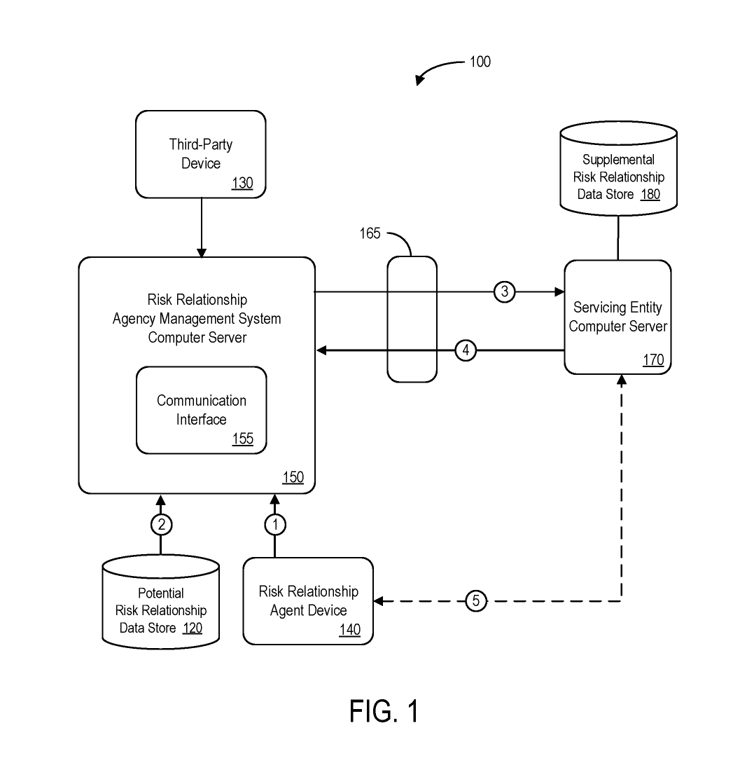

It would therefore be desirable to provide systems and methods to facilitate the offering of a supplemental risk relationship to an entity in an automated, efficient, and accurate manner. FIG. 1 is a high-level block diagram of a system 100 according to some embodiments of the present invention. In particular, the system 100 includes a risk relationship agency management system computer server 150 that may access information in a potential risk relationship data store 120 (e.g., storing a set of electronic records including potential risk relationship identifiers, remote risk relationship agent device identifiers, indications associated with potential risk relationship categories, entity descriptions, etc.). The risk relationship agency management system computer server 150 may also exchange information with a remote servicing entity computer server 170 (e.g., via a firewall 165). According to some embodiments, a communication interface 155 of the risk relationship agency management system computer server 150 may receive information from a risk relationship agent device 140, access information in the potential risk relationship data store 120, and communicate with the servicing entity computer server 170 to facilitate the presentation of interactive user interface displays to an insurance agent. According to some embodiments, the servicing entity computer server 170 may store information into a supplemental risk relationship data store 180 (e.g., in connection with the management of issued excess and surplus insurance policies). Note that the risk relationship agency management system computer server 150 might also be associated with a third party, such as a vendor that performs a service for an enterprise. Moreover, information from a third-party device 130 might be used to pre-populate, supplement, and/or verify information processed by the system 100.

The risk relationship agency management system computer server 150 might be, for example, associated with a Personal Computer (“PC”), laptop computer, smartphone, an enterprise server, a server farm, and/or a database or similar storage devices. According to some embodiments, an “automated” risk relationship agency management system computer server 150 may automatically facilitate the presentation of interactive user interface displays. As used herein, the term “automated” may refer to, for example, actions that can be performed with little (or no) intervention by a human.

As used herein, devices, including those associated with the risk relationship agency management system computer server 150 and any other device described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The risk relationship agency management system computer server 150 may store information into and/or retrieve information from the potential risk relationship data store 120. The potential risk relationship data store 120 may contain data that was downloaded and/or that was originally input by employees of an enterprise. The potential risk relationship data store 120 may be locally stored or reside remote from the risk relationship agency management system computer server 150. As will be described further below, the potential risk relationship data store 120 may be used by the risk relationship agency management system computer server 150 to facilitate an automatic exchange information with an insurance agent. Although a single risk relationship agency management system computer server 150 is shown in FIG. 1, any number of such devices may be included. Moreover, various devices described herein might be combined according to embodiments of the present invention. For example, in some embodiments, the risk relationship agency management system computer server 150 and potential risk relationship data store 120 might be co-located and/or may comprise a single apparatus.

According to some embodiments, the system 100 may automatically facilitate an exchange of information via interactive user interface displays. For example, at (1) an insurance agent may use a risk relationship agent device 140 to provide information to the risk relationship agency management system computer server 150. For example, the insurance agent might provide information about a potential customer along with a request for an excess and surplus insurance quote. At (2), the risk relationship agency management system computer server 150 may obtain information from the potential risk relationship data store 120 and transmit a quote request to the servicing entity computer server 170 at (3). At (4), the servicing entity computer server 170 may then respond to the quote request. According to some embodiments, the servicing entity computer server 170 and risk relationship agent device 140 may exchange information directly during an underwriting process (as illustrated by the dashed line in FIG. 1).

According to some embodiments, risk relationship agent device 140 and or risk relationship agency management system computer server 150 may communicate with a potential customer device. For example, the risk relationship agency management system computer server might be adapted to communicate with a front-end potential risk relationship entity device such as a PC, a tablet computer, a smartphone, a television device, a gaming device, etc. to receive and/or provide information associated with a supplemental risk relationship.

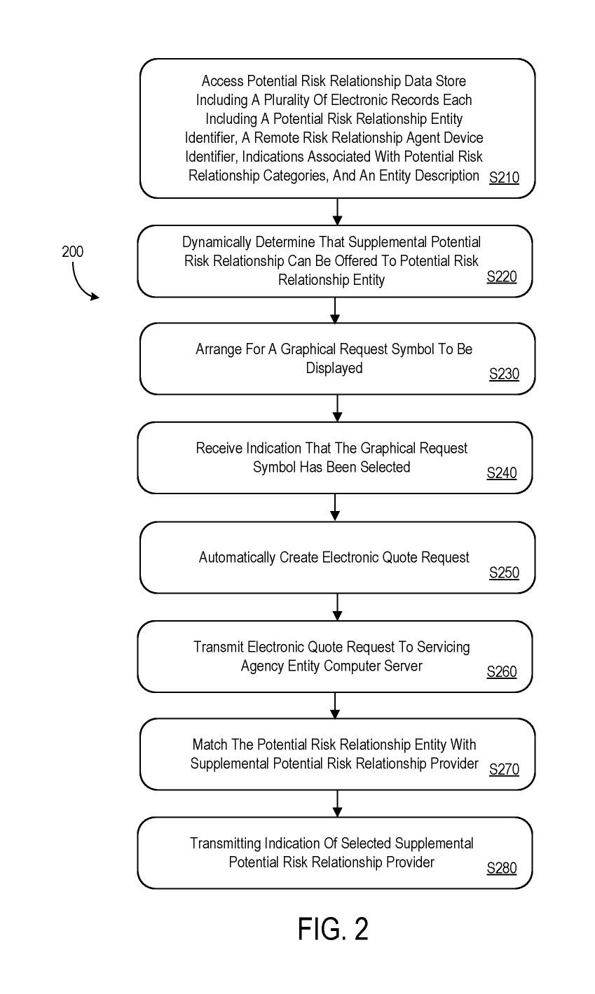

Thus, some embodiments may facilitate the offering of a supplemental risk relationship to an entity in an automated, efficient, and accurate manner. Note that the system 100 of FIG. 1 is provided only as an example, and embodiments may be associated with additional elements or components. According to some embodiments, the elements of the system 100 automatically support interactive user interface displays over a distributed communication network. For example, FIG. 2 illustrates a method 200 that might be performed by some or all of the elements of the system 100 described with respect to FIG. 1, or any other system, according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S210, a computer processor of a risk relationship agency management system computer server may access a potential risk relationship data store. The potential risk relationship data store may include, for example, a plurality of electronic records each including a potential risk relationship entity identifier, a remote risk relationship agent device identifier, indications associated with potential risk relationship categories, an entity description, etc. According to some embodiments the potential risk relationship entity identifier is associated an entity that has a pre-existing relationship with the risk relationship agent (e.g., a pre-existing insurance customer). According to other embodiments, the entity is an entirely new entity. The potential risk relationship entity identifier might be associated with, for example, an entity name, an entity policy number, a communication address (e.g., a telephone number, email address, IP address, etc.), a postal address, an effective date, a geographic location (e.g., a US state or ZIP code), and/or a Federal Employer Identification Number (“FEIN”). The entity description might be associated with, for example, an industry classification, an industry classification code,) an industry classification description, etc.

In some cases, the supplemental potential risk relationship is associated with an excess and surplus insurance policy. When that is the case, indications associated with potential risk relationship categories might be associated with commercial insurance, property and liability insurance, workers' compensation insurance, business automobile insurance, etc.

Based on the indications associated with the potential risk relationship categories and the entity description, the system may dynamically determine at S220 that a supplemental potential risk relationship can be offered to the potential risk relationship entity. For example, a risk relationship agency management system computer may determine that an excess and surplus insurance policy can be offered to a potential risk relationship entity when at least one of indications associated with potential risk relationship categories is valid. In the case of excess and surplus insurance, a policy might only be offered to a potential customer along with at least one other form of insurance (e.g., insurance for which an agent is admitted within the state).

At S230, the system may exchange information (via a distributed communication network) with a remote risk relationship agent device associated with the remote risk relationship agent device identifier to arrange for a graphical request icon or symbol to be displayed. That is, when the supplemental potential risk relationship can be offered to the entity, the “request symbol” is displayed (otherwise the symbol may be completely removed, grayed out, crossed out, etc.).

At S240, the system may receive from the remote risk relationship agent device an indication that the graphical request symbol has been selected. Responsive to the selection, the system may automatically create at S250 an electronic quote request that includes the potential risk relationship entity identifier, the remote risk relationship agent device identifier, and the entity description. At S260, the system may transmit the electronic quote request to a servicing agency entity computer server. The service entity computer server might be associated with, for example, a non-admitted insurance broker, an alternate marketplace placement team, and/or a wholesaler. According to some embodiments, the risk relationship agency management system computer server automatically attaches supplemental application documentation to the electronic quote request. Moreover, at least some of the data in the supplemental application documentation might automatically obtained from a third-party device, such as a device associated with a Customer Relationship Management (“CRM”) platform, a governmental platform, a real estate platform, a credit score platform, a search platform, a social media site, and/or an advertisement system. According to some embodiments, information from the third-party device is further used to validate data received from the potential risk relationship entity.

Responsive to the quote request, the computer processor of the servicing agency entity computer server may arrange at S270 to match the potential risk relationship entity with a selected one of a plurality of supplemental potential risk relationship providers. At S280, an indication of the selected supplemental potential risk relationship provider may be transmitted from the servicing agency entity computer server to the risk relationship agency management system computer server.

According to some embodiments, the servicing entity computer server is also configured to perform other processes (e.g., after an excess and surplus insurance policy is sold. For example, the servicing entity computer server may generate a consolidated billing statement associated with the excess and surplus insurance policy and at least one other risk relationship category (e.g., both admitted and non-admitted insurance policies may be billed together). As another example, the servicing entity computer server may automatically modify a payment arrangement with the excess and surplus insurance policy payment plan into a modified payment arrangement (e.g., to avoid requiring the customer to make a complete yearly payment upfront). As other examples, the servicing entity computer server may perform a renewal process associated with a termination date of the excess and surplus insurance policy and/or generate a consolidated commission statement associated with the excess and surplus insurance policy.

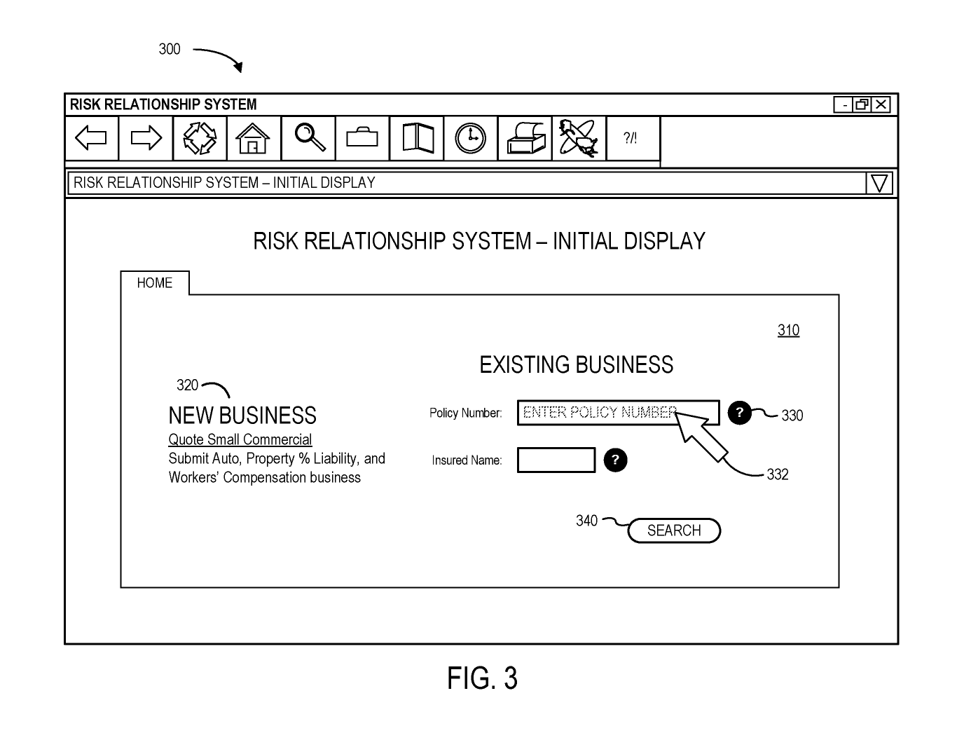

According to some embodiments, the system may use interactive displays to exchange information with an insurance agent. For example, FIG. 3 is an electronic business center home page display 300 in accordance with some embodiments. The display 300 might be associated with an insurance agency management system and includes a data entry area 310 that can be used by an insurance agent to initiate a new business process 320 (e.g., by selecting the “Quote Small Commercial” hyperlink). The display 300 can also be used to request additional detailed information or instructions 330 (e.g., when the “?” symbol is selected by touchscreen or computer mouse pointer 332) and/or search for existing customers via a “Search” symbol 340. According to some embodiments, the display 300 might further include information and/or links to help an insurance agent manage policies, bill customers, monitor claims, access recent news items, etc.

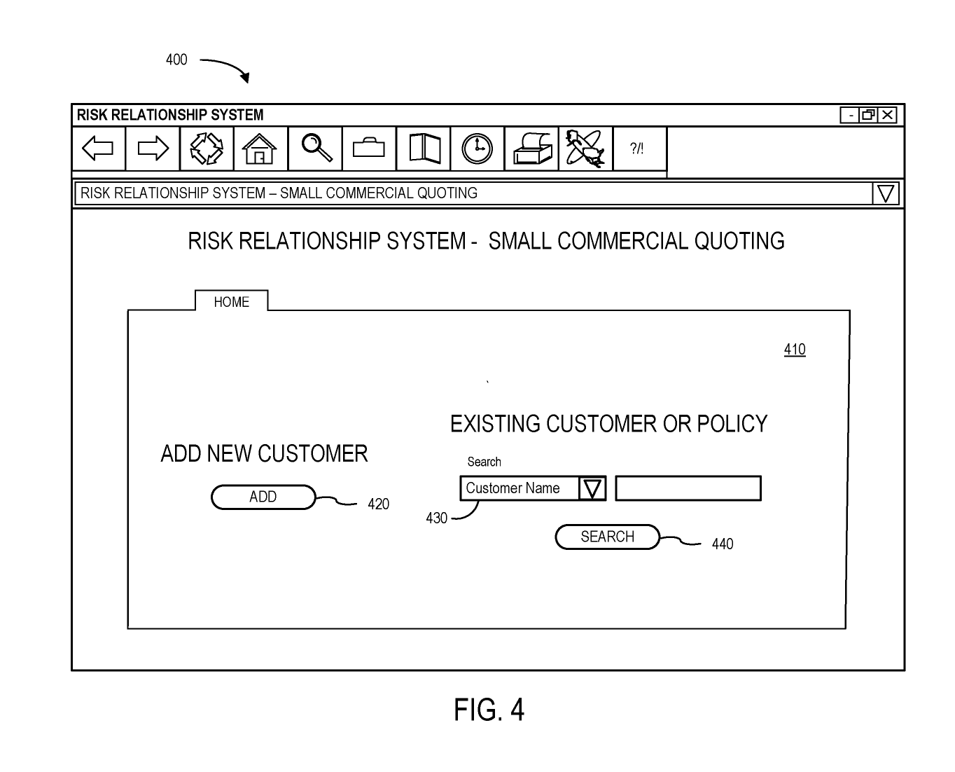

Selection of the “Quote Small Commercial” hyperlink may result in an account management display 400 as illustrated in FIG. 4. The display includes a data entry area 410 that can be used by the insurance agent to initiate a new customer process by selection of an “Add” symbol 420. According to some embodiments, the insurance agent may instead select a search parameter 430, enter text, and initiate a search for an existing customer via a “Search” symbol 440. Note that embodiments may be used for entirely new customers and/or to provide excess and surplus insurance to existing customers (e.g., when they are renewing other types of insurance policies). According to some embodiments, the display 400 might further include links to important resources, recent quote activity, etc.

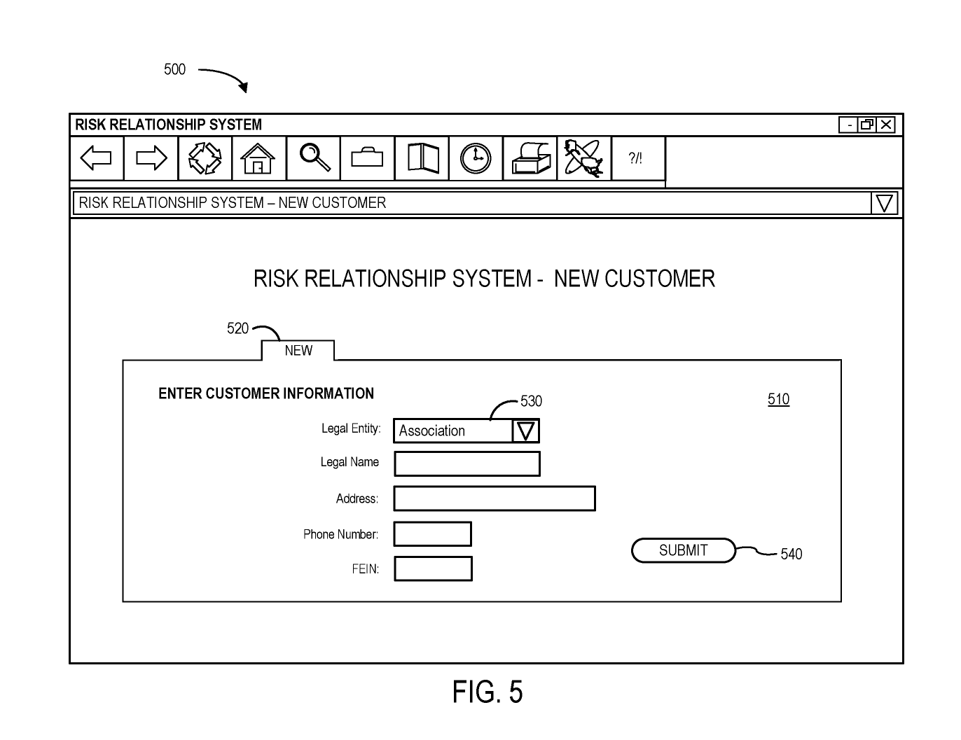

FIG. 5 is new customer display 500 that might be presented when an insurance agent selects the “Add” symbol 420 in accordance with some embodiments. The display 500 includes a data entry area 510 (e.g., associated with a “New” tab 520) than insurance agent can use to enter customer information. For example, the insurance agent might select a legal entity type from a dropdown menu 530 and enter a legal name, address, telephone number, FEIN, etc. According to some embodiments, the display 500 might also be used to enter a jurisdiction (e.g., a state when the potential customer does business), a producer code, an operational category (e.g., indicating the customer is a member of commercial condominium association), etc.

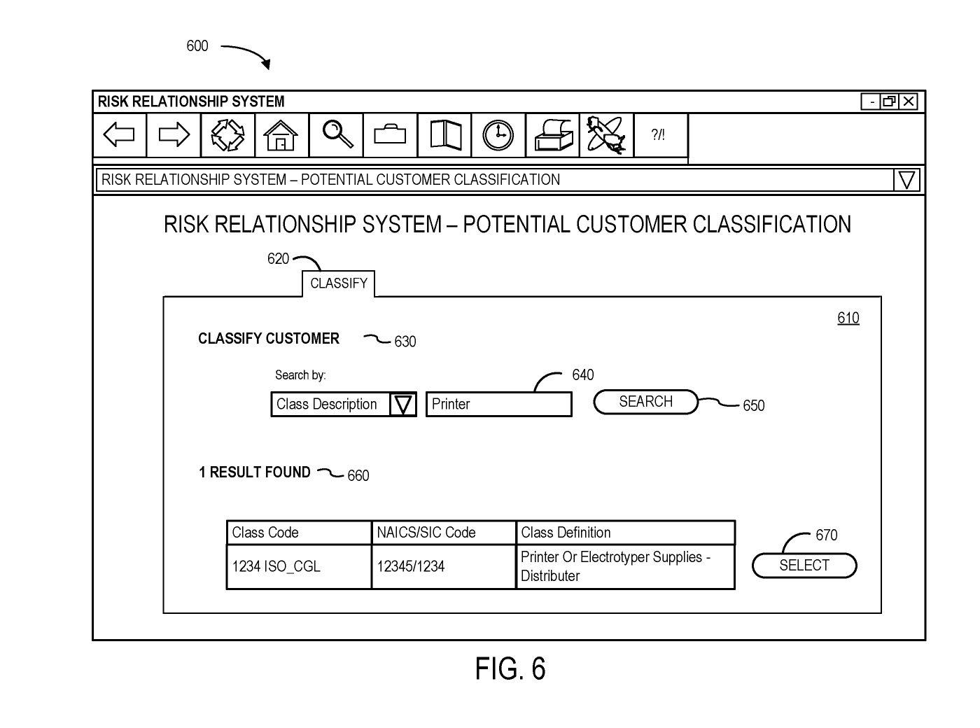

After entering the new customer information, the insurance agent might provide a customer classification to the system. For example, FIG. 6 is a customer classification display 600 according to some embodiments of the present invention. The display 600 includes a data entry area 610 (e.g., associated with a “Classify” tab 620) that can be used to classify a customer 630. For example, an insurance agent might select a class description via a dropdown menu, enter text 640, and select a “Search” symbol 650. The system may then present a list results 660 found during the search. The results 660 might include, for example, a class code (e.g., associated with an Insurance Services Office (“ISO”) Commercial General Liability (“CGL”) number), a North American Industry Classification System (“NAICS”) code and/or Standard Industrial Classification (“SIC”) code, and a class definition. The insurance agent may then indicate which result 660 best describes the customer via selection of a “Select” symbol 670. According to some embodiments, the searches performed via the display 600 are tailored in accordance with local state regulations (e.g., a New York search might return different results 660 as compared to California search).

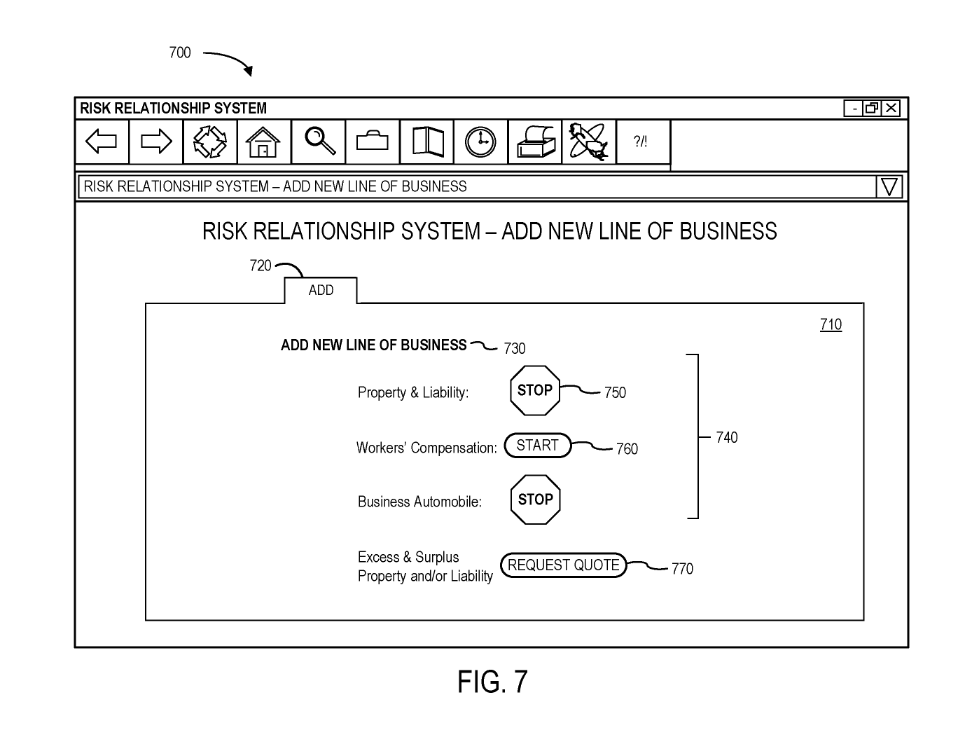

Once the insurance agent has entered the customer information and provided a classification, he or she can select one or more types of insurance that might be offered to the customer. For example, FIG. 7 is a new line of business display 700 in accordance with some embodiments. The display 700 includes a data entry area 710 (e.g., associated with an “Add” tab 720) that displays what new lines of business 740 are available to be added 730 for the customer. In the example of FIG. 7, “worker's compensation” insurance is available (as indicated by the “Start” symbol 760) and “property and liability” and “business automobile” insurance is not available (as indicated by the “Stop” symbols 750). According to some embodiments, selection of a “Stop” symbol 750 might provide further details about what that type of insurance is not currently available for selection (e.g., perhaps the insurance agent needs to provide further information). When at least one of the three admitted lines of insurance 740 are available, and the classification of the customer matches the requirements of at least one servicing entity or non-admitted wholesaler (e.g., is aligned with risk appetite), a “Request Quote” symbol 770 is displayed in connection with excess and surplus property and/or liability insurance.

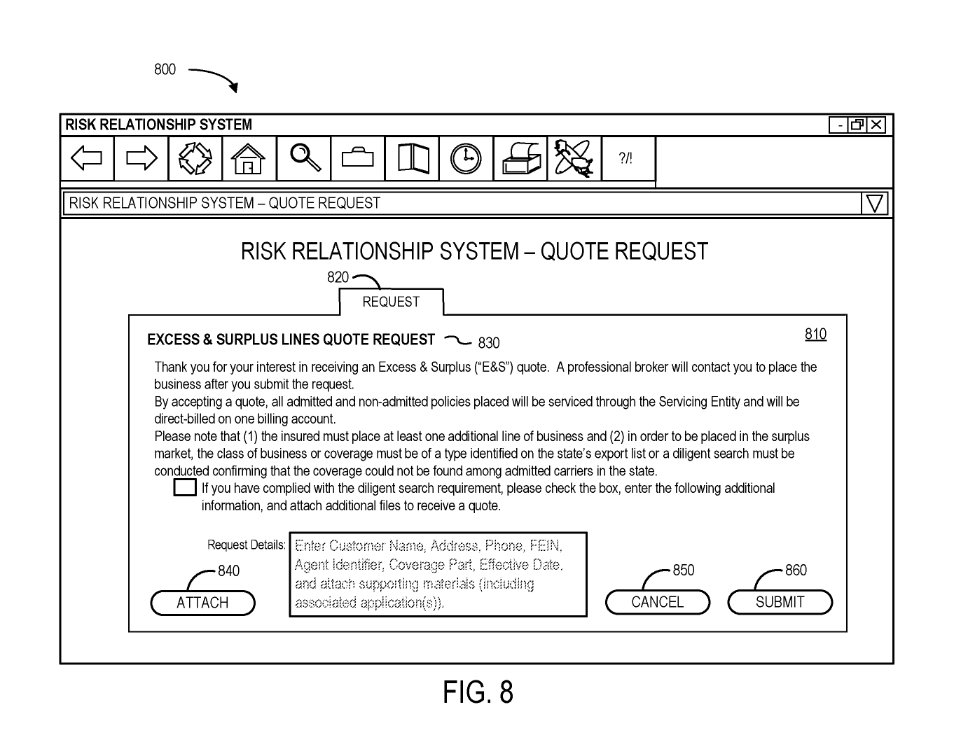

Selection of the “Request Quote” symbol will result in a quote request being prepared for the insurance agent. For example, FIG. 8 is an excess and surplus lines quote request display 800 according to some embodiments of the present invention. The display 800 includes a data entry area 810 (e.g., associated with a “Request” tab 820) that presents an excess and surplus lines quote request 830. In some cases, the insurance agent is able to indicate that a “diligent search” requirement has been complied with, provide additional request details, and/or modify automatically populated request details. According to some embodiments, the insurance agent may have the option of selecting an “Attach” symbol 840 (e.g., to append a document to the request) or a “Cancel” symbol 850 (e.g., to return to a prior screen with submitting the request).

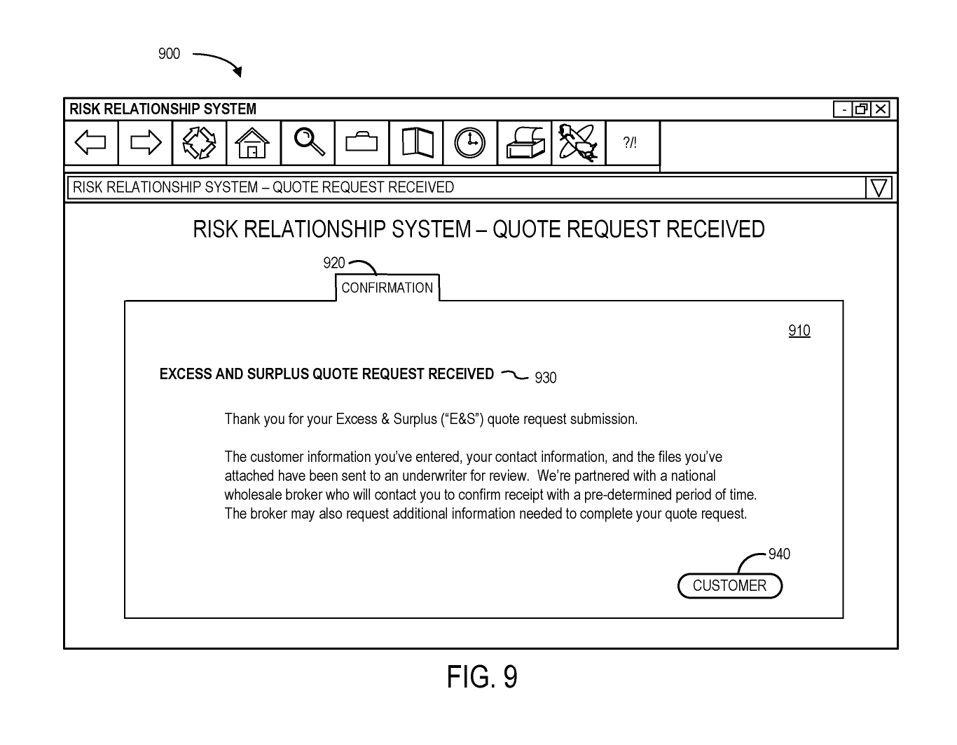

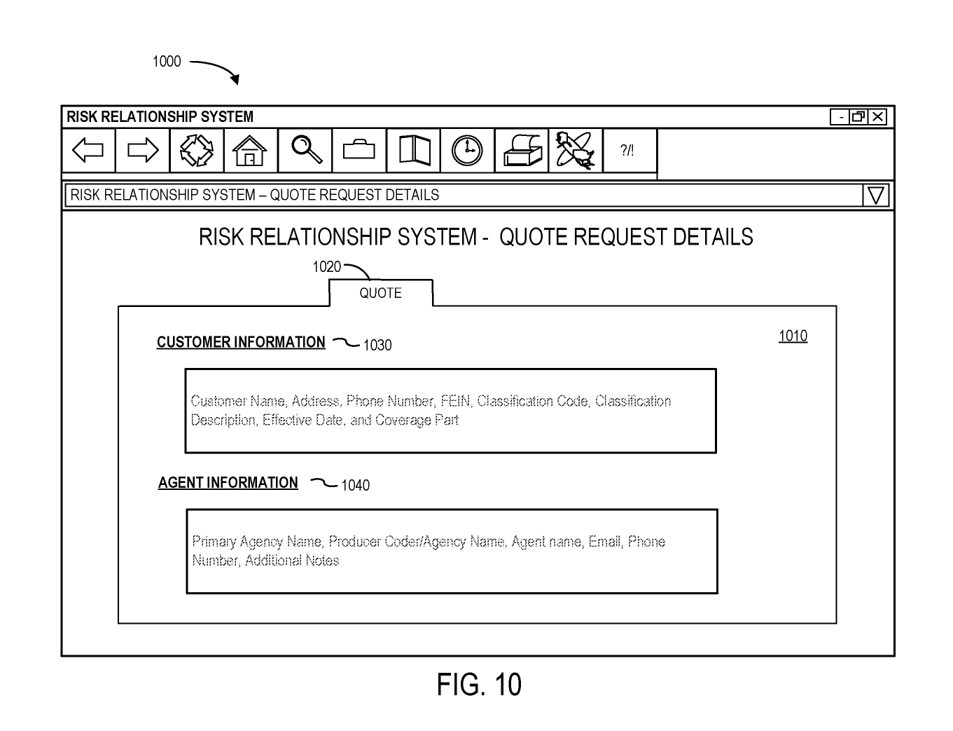

Selection of a “Submit” symbol 860 will result in the automatic creation and transmission of a quote request to a servicing entity computer server. For example, FIG. 9 is an excess and surplus quote request acknowledgement display 900 in accordance with some embodiments. The display 900 includes a data presentation area 910 (e.g., associated with a “Confirmation” tab 920) that presents an acknowledgement that the excess and surplus quote request has been received 930. Selection of a “Customer” symbol 940 may return the insurance agent to a prior display. FIG. 10 is a quote request details display 1000 according to some embodiments of the present invention. The display 1000 includes a data presentation area 1010 (e.g., associated with a “Quote” tab 1020) that presents a summary of the customer information 1030 and agent information 1040 that was provided to the servicing entity in the request.

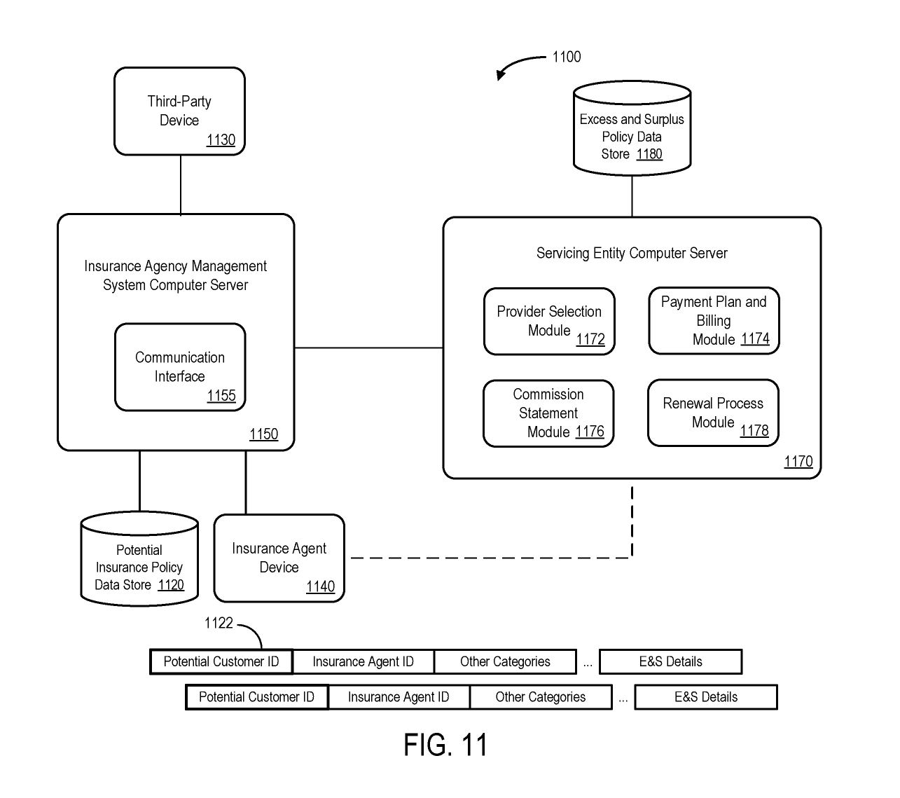

Thus, the user interfaces of FIGS. 3 through 10 may be used to facilitate the same of excess and surplus life insurance policies. FIG. 11 is a detailed block diagram of a system 1100 according to some embodiments. As before, the system 1100 includes an insurance agency management system computer server 1150 that may access information in a potential insurance policy data store 1120 (e.g., storing a set of electronic records 1122 including potential insurance customer identifiers, insurance agent device identifiers, indications associated with potential insurance categories, entity descriptions, etc.). The insurance agency management system computer server 1150 may also exchange information with a remote servicing entity computer server 1170. According to some embodiments, a communication interface 1155 of the insurance agency management system computer server 1150 may receive information from an insurance agent device 1140, access information in the potential insurance policy data store 1120, and communicate with the servicing entity computer server 1170 (which in turn may store information into an excess and surplus policy data store 1180) to facilitate the presentation of interactive user interface displays to an insurance agent.

According to some embodiments, the servicing entity computer server 1170 may store information into the excess and surplus policy data store 1180 in connection with the management of issued excess and surplus insurance policies that are issued in accordance with a provider selection module 1172. For example, the servicing entity computer server 1170 may manage insurance policies using a payment plan and billing module 1174, a consolidated commission statement 1176, a renewal process module 1178, etc. Note that the insurance agency management system computer server 1150 might also be associated with a third party, such as a vendor that performs a service for an enterprise. Moreover, information from a third-party device 1130 might be used to pre-populate, supplement, and/or verify information processed by the system 1100.

According to some embodiments, the system 1100 may automatically facilitate an exchange of information via interactive user interface displays. For example, an insurance agent may use the insurance agent device 1140 to provide information to the insurance agency management system computer server 1150. For example, the insurance agent might provide information about a potential customer (including an industry classification) along with a request for an excess and surplus insurance quote. The insurance agency management system computer server 1150 may obtain information from the potential insurance policy data store 1120 and transmit a quote request to the servicing entity computer server 1170. The servicing entity computer server 1170 may then respond to the quote request. According to some embodiments, the servicing entity computer server 1170 and insurance agent device 1140 may exchange information directly during an underwriting process (as illustrated by the dashed line in FIG. 11).

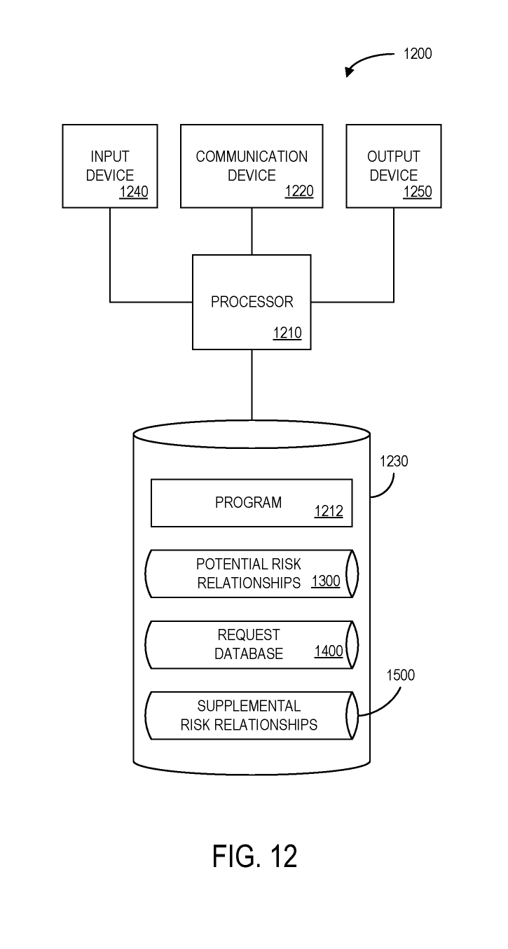

Embodiments described herein may comprise a tool to facilitate the sale of excess and surplus insurance policies and may be implemented using any number of different hardware configurations. For example, FIG. 12 illustrates a risk relationship agency management system computer server, apparatus, or platform 1200 that may be, for example, associated with the systems 100, 1100 of FIGS. 1 and 11, respectively. The platform 1200 comprises a processor 1210, such as one or more commercially available Central Processing Units (“CPUs”) in the form of one-chip microprocessors, coupled to a communication device 1220 configured to communicate via a communication network (not shown in FIG. 12). The communication device 1220 may be used to communicate, for example, with one or more remote insurance agent devices (e.g., PCs and smartphones), third-party devices, servicing entity computer servers, customer devices, etc. Note that communications exchanged via the communication device 1220 may utilize security features, such as those between a public interne user and an internal network of an insurance enterprise. The security features might be associated with, for example, web servers, firewalls, and/or PCI infrastructure. The platform 1200 further includes an input device 1240 (e.g., a mouse and/or keyboard to enter information about descriptive terms, excess and surplus insurance, etc.) and an output device 1250 (e.g., to transmit system administration messages, generate reports, etc.).

The processor 1210 also communicates with a storage device 1230. The storage device 1230 may comprise any appropriate information storage device, including combinations of magnetic storage devices (e.g., a hard disk drive), optical storage devices, mobile telephones, and/or semiconductor memory devices. The storage device 1230 stores a program 1212 and/or an interface application for controlling the processor 1210. The processor 1210 performs instructions of the program 1212, and thereby operates in accordance with any of the embodiments described herein. For example, the processor 1210 may access information in a potential risk relationship data store. Based on indications associated with potential risk relationship categories and an entity description, the processor 1210 may determine that a supplemental potential risk relationship can be offered to a potential risk relationship entity, and, as a result, a graphical request symbol may be displayed. Upon selection of the request symbol, the processor 1210 may create an electronic quote request that includes a potential risk relationship entity identifier, a remote risk relationship agent device identifier, and the entity description. A servicing entity computer server may then arrange to match the potential risk relationship entity with a selected supplemental potential risk relationship provider.

The program 1212 may be stored in a compressed, uncompiled and/or encrypted format. The program 1212 may furthermore include other program elements, such as an operating system, a database management system, and/or device drivers used by the processor 1210 to interface with peripheral devices.

As used herein, information may be “received” by or “transmitted” to, for example: (i) the platform 1200 from another device; or (ii) a software application or module within the platform 1200 from another software application, module, or any other source.

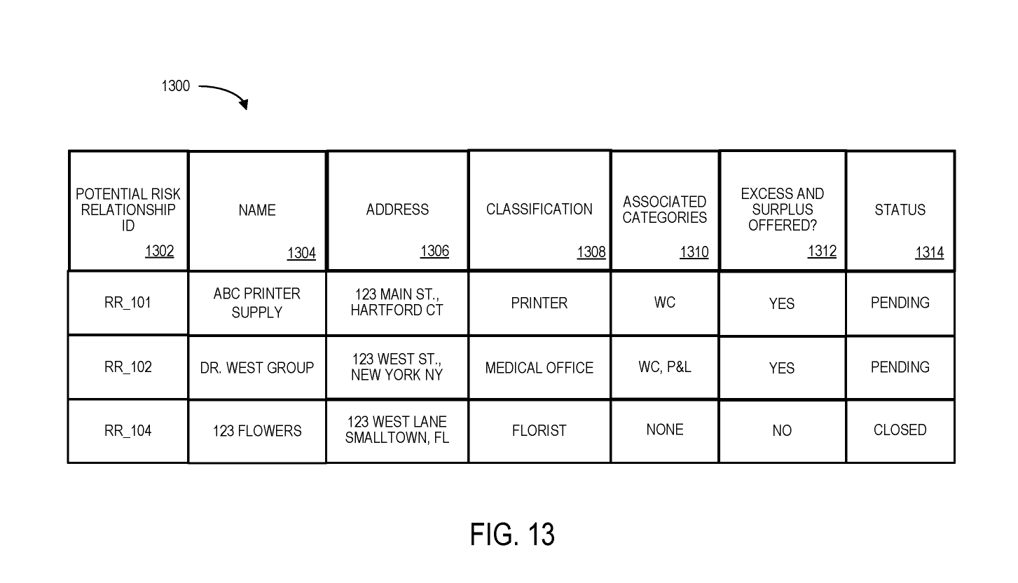

In some embodiments (such as shown in FIG. 12), the storage device 1230 further stores a potential risk relationship database 1300, a request database 1400, and a supplemental risk relationship database 1500. Examples of databases that might be used in connection with the platform 1200 will now be described in detail with respect to FIGS. 13 through 15. Note that the database described herein is only an example, and additional and/or different information may be stored therein. Moreover, various databases might be split or combined in accordance with any of the embodiments described herein. For example, the request database 1400 and/or supplemental risk relationship database 1500 might be combined and/or linked to each other within the program 1212.

Referring to FIG. 13, a table is shown that represents the potential risk relationship database 1300 that may be stored at the platform 1200 according to some embodiments. The table may include, for example, entries identifying potential risk relationships that an insurance agents is investigating for consumers. The table may also define fields 1302, 1304, 1306, 1308, 1310, 1312, 1314 for each of the entries. The fields 1302, 1304, 1306, 1308, 1310, 1312, 1314 may, according to some embodiments, specify: a potential risk relationship identifier 1302, a name 1304, an address 1306, a classification 1308, associated categories 1310, an indication of whether or not excess and surplus insurance will be offered to the customer 1312, and a status 1314. The request database 1300 may be created and updated, for example, based on information electrically received from remote front-end user devices.

The potential relationship request identifier 1302 may be, for example, a unique alphanumeric code identifying a potential customer and one or more potential insurance policies (e.g., “RR_101”). The name 1304 and an address 1306 may define the customer and the classification 1308 might indicate the customer's primary type of business. The associated categories 1310 reflects whether the customer is purchasing an admitted type of insurance. The indication of whether or not excess and surplus insurance (e.g., non-admitted insurance) will be offered to the customer 1312 might be based on, for example, the classification 1308 (e.g., is an excess and surplus insurance provider interested in that particular type of business) and the associated categories 1310 (e.g., is the customer also purchasing an admitted type of insurance?). The status 1314 might indicate that the potential sale is “pending,” “closed,” etc.

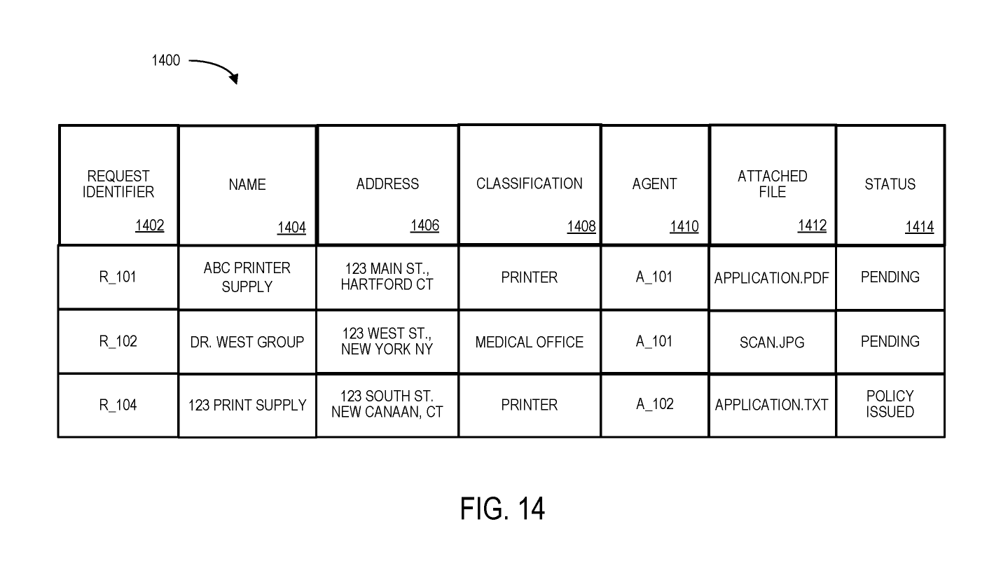

Referring to FIG. 14, a table is shown that represents the request database 1400 that may be stored at the platform 1200 according to some embodiments. The table may include, for example, entries identifying potential supplemental risk relationship requests generated by an insurance agent (e.g., via an agency management system) for a potential customer. The table may also define fields 1402, 1404, 1406, 1408, 1410, 1412, 1414 for each of the entries. The fields 1402, 1404, 1406, 1408, 1410, 1412, 1414 may, according to some embodiments, specify: a potential relationship request identifier 1402, a name 1404, an address 1406, classification 1408, an agent 1410, an attached file 1412, and status 1414. The request database 1400 may be created and updated, for example, based on information electrically received from remote insurance agent and/or customer devices.

The potential relationship request identifier 1402 may be, for example, a unique alphanumeric code identifying a request for supplemental insurance (e.g., excess and surplus insurance). The name 1404, address 1406, and classification 1408 indicate who is seeking the insurance and may be based on or associated with the name 1304, address 1306, and classification 1308 stored in the potential risk relationship database 1300. The agent 1410 may indicate who submitted the request for the potential customer. The attached file 1412 might represent (or be a pointer to) supplemental information, supporting documentation, an additional insurance application, etc. According to some embodiments, the attached file 1412 might be manually inserted by an agent our automatically included by the system. The status 1414 might indicate that the request is “pending,” an insurance policy has “issued,” etc.

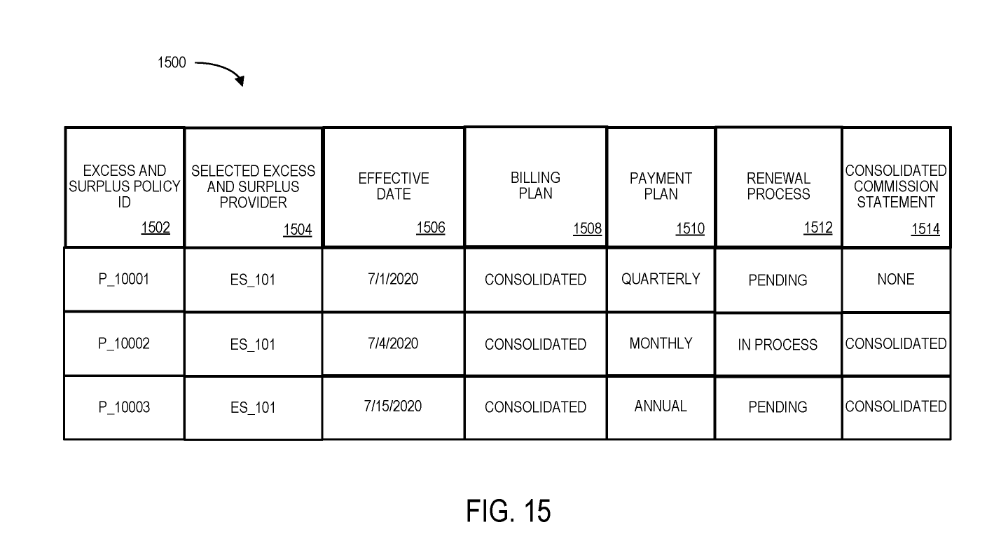

FIG. 15 is a portion of a supplemental risk relationship database 1500 in accordance with some embodiments. The table may include, for example, entries identifying risk relationships that have been established for customers. The table may also define fields 1502, 1504, 1506, 1508, 1510, 1512, 1514 for each of the entries. The fields 1502, 1504, 1506, 1508, 1510, 1512, 1514 may, according to some embodiments, specify: an excess and surplus policy identifier 1502, a selected excess and surplus provider 1504, an effective date 1506, a billing plan 1508, payment plan 1510, a renewal process 1512, and a consolidated commission statement 1514. The request database 1500 may be created and updated, for example, based on information electrically received from an excess and surplus insurance enterprise.

The excess and surplus policy identifier 1502 may be, for example, a unique alphanumeric code identifying an insurance policy being maintained by servicing entity. The selected excess and surplus provider 1504 might indicate the party who issued the insurance policy and the effective date 1506 may indicate when the insurance policy went into effect. The billing plan 1508 might, for example, indicate that non-admitted and admitted insurance policies are being combined in a single billing statement. The payment plan 1510 might indicate that the servicing entity has arranged for the customer to provide periodic payment (and may have already paid the provider for the entire year's premium upfront). The renewal process 1512 might indicate that the servicing entity has initiated a renewal process, has scheduled a renewal process, etc. The consolidated commission statement 1514 might indicate that a single statement may list multiple commission values for an insurance agent, excess and surplice insurance provider, or any other entity.

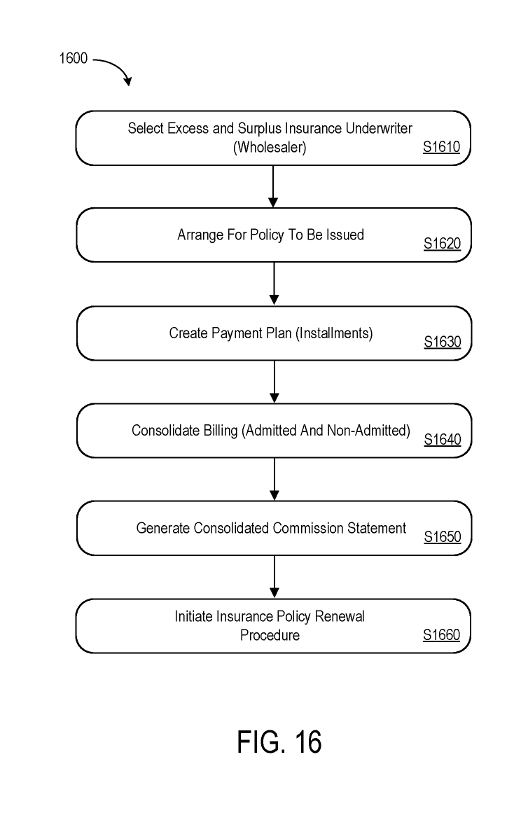

FIG. 16 illustrates a servicing entity method 1600 according to some embodiments. At S1610, the servicing entity may select an excess and surplus insurance underwriter or wholesaler for a customer and insurance agent. For example, the servicing entity might select a preferred provider if the classification of the customer's business matches the preferred provider's risk appetite. Otherwise, a provider might be selected from a pool of non-preferred providers. At S1620, the servicing entity, insurance agent, and provider might work together to arrange for the excess and surplus insurance policy will be issued. In some cases, the servicing entity might provide a premium payment to the provide and create a payment plan at S1630 to receive payments from the customer (e.g., on a monthly or quarterly basis). At S1640, the servicing entity may consolidate billing such that that non-admitted (e.g., excess and surplus) and admitted (e.g., workers' compensation) insurance policies are combined in a single billing statement. At S1650, the servicing entity may generate single statement that lists multiple commission values for an insurance agent, excess and surplice insurance provider, or any other entity. At S1660, the servicing entity may begin a renewal process, scheduled a renewal process to begin on a pre-determined date (e.g., 30 days before a prior policy expires), etc.

Thus, embodiments may facilitate the offering of a supplemental risk relationship to an entity in an automated, efficient, and accurate manner. This may help streamline communications, reduce the number of messages that need to be exchanged, reduce errors, etc.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

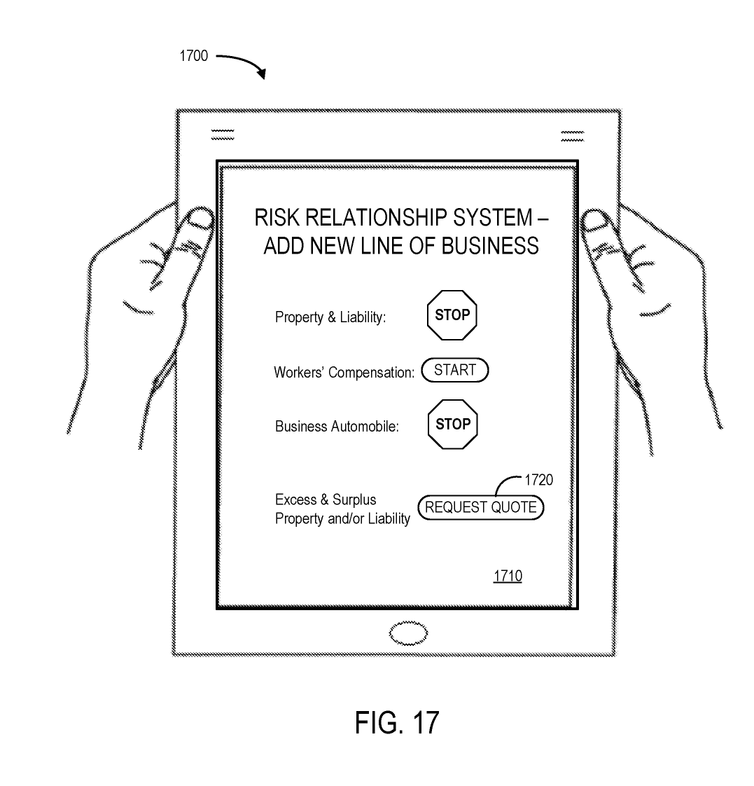

Although specific hardware and data configurations have been described herein, note that any number of other configurations may be provided in accordance with embodiments of the present invention (e.g., some of the information associated with the displays described herein might be implemented as a virtual or augmented reality display and/or any of the embodiments might be implemented using a cloud based computing platform). Moreover, although embodiments have been described with respect to particular types of insurance policies, embodiments may instead be associated with other types of insurance. Still further, the displays and devices illustrated herein are only provided as examples, and embodiments may be associated with any other types of user interfaces. For example, FIG. 17 illustrates a handheld touchscreen tablet computer 1700 with an initial display 1710 according to some embodiments. In particular, the display 1710 includes user-selectable touchscreen symbols, including a request quote symbol 1720, that let an insurance agent ask for an excess and surplus insurance policy quote for a potential customer. According to some embodiments, a display may let a user chat with a representative of an enterprise (e.g., a text-based chat or a video chat) and/or arrange to provide a payment to the enterprise (e.g., to provide payment of an insurance premium via a credit card or other payment option).

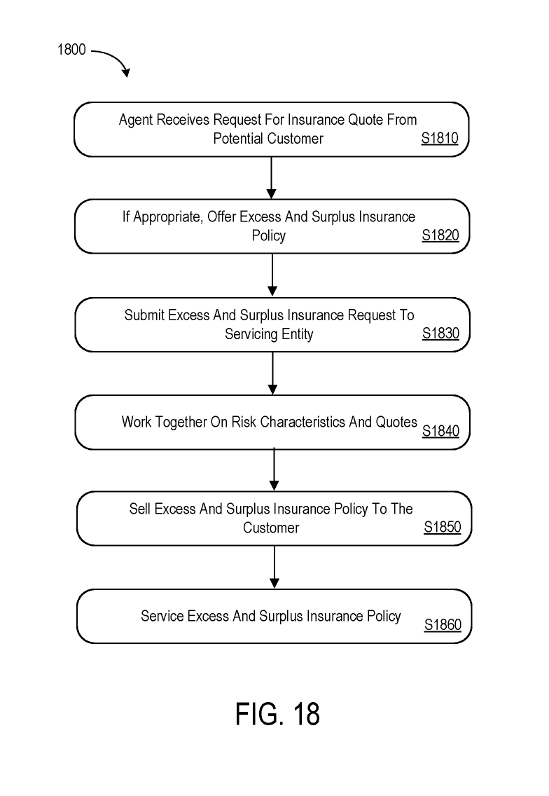

Note that embodiments described herein might be used in connection with a number of different types of business process flows. For example, FIG. 18 illustrates an overall process 1800 that might be associated with an insurance enterprise in accordance with some embodiments. At S1810, an insurance agent receives a request for an insurance quote from a potential customer. For example, the potential customer might ask for a workers' compensation insurance quote from the insurance agent. At S1820, an excess and surplus insurance may be offered to the potential customer if appropriate. For example, an excess and surplus insurance offer might be provide to potential customer who both: (1) are also considering purchasing an admitted type of insurance from the agent (e.g., a servicing entity might avoid selling a standalone excess and surplus insurance policy) and (2) is classified as a type of business (e.g., retailer, florist, etc.) that one or more non-admitted providers are interested in insuring. At S1830, assuming the insurance agent and/or potential customer are interested, a request for excess and surplus insurance may be transmitted to a servicing entity. The servicing entity, insurance agent, and/or potential customer may then work together at S1840 to determine risk characteristics such that an appropriate quote may be generated. At S1850, an excess and surplus insurance policy policy may be sold to the customer. The system may then arrange to service the excess and surplus insurance policy at S1860 (e.g., by implementing a payment plan, generating combined commission statements, handling a renewal process, etc.).

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed:

1. A system useful to facilitate a data exchange between risk relationship agent device and an automated back-end risk relationship agency management system computer server, comprising:
(a) a potential risk relationship data store including a plurality of electronic records each including a potential risk relationship entity identifier, a remote risk relationship agent device identifier, indications associated with potential risk relationship categories, and an entity description;
(b) a computer store containing data, for each of a plurality of web pages, defining a plurality of visually perceptible elements;
(i) wherein a first of the web pages includes a potential risk relationship entity identifier input element, and
(ii) wherein a second of the web pages includes a dynamic supplemental potential risk relationship request symbol;
(d) the automated back-end risk relationship agency management system computer server, coupled to the computer store and the potential risk relationship data store, programmed to:
(i) receive directly from a web browser of a remote risk relationship agent device a signal indicating a process initiation,
(ii) receive, via the potential risk relationship entity identifier input element of the first of the web pages, a potential risk relationship identifier,
(iii) perform a look-up process based on the potential risk relationship entity identifier to determine associated indications associated with potential risk relationship categories and an entity description,
(iv) based on the indications associated with the potential risk relationship categories and the entity description, arrange for the dynamic supplemental potential risk relationship request symbol to be displayed on the second of the web pages,
(v) receive from the remote risk relationship agent device an indication that the supplemental potential risk relationship request symbol has been selected,
(vi) responsive to the selection, automatically create an electronic quote request that includes the potential risk relationship entity identifier, the remote risk relationship agent device identifier, and the entity description, and
(vii) transmit the electronic quote request to a servicing agency entity computer server adapted to respond with a selected one of a plurality of supplemental potential risk relationship providers, and
(viii) automatically generate and transmit directly to the web browser a results web page that displays:
(A) the selected one of a plurality of supplemental potential risk relationship providers, and (B) a user-selectable symbol to establish communication between the remote risk relationship agent device and the servicing agency entity computer.

2. The system of claim 1, wherein the automated back-end risk relationship agency management system computer server is adapted to communicate with different types of remote risk relationship agent devices, and further wherein information displayed on the results web page is presented based on the type of device.

3. A system to facilitate supplemental risk relationships, comprising:
(a) a potential risk relationship data store including a plurality of electronic records each including a potential risk relationship entity identifier, a remote risk relationship agent device identifier, indications associated with potential risk relationship categories, and an entity description;
(b) a communication interface to facilitate an exchange of electronic messages, including messages exchanged via a distributed communication network, supporting interactive user interface displays at remote devices of risk relationship agents;
(c) a risk relationship agency management system computer server, coupled to the potential risk relationship data store and the communication interface, including memory and a computer processor programmed to:
(i) access information in the potential risk relationship data store,
(ii) based on the indications associated with the potential risk relationship categories and the entity description, dynamically determine that a supplemental potential risk relationship can be offered to the potential risk relationship entity,
(iii) exchange information with a remote risk relationship agent device associated with the remote risk relationship agent device identifier to arrange for a graphical request symbol to be displayed,
(iv) receive from the remote risk relationship agent device an indication that the graphical request symbol has been selected,
(v) responsive to the selection, automatically create an electronic quote request that includes the potential risk relationship entity identifier, the remote risk relationship agent device identifier, and the entity description, and
(vi) transmit the electronic quote request to a servicing agency entity computer server; and
(d) the servicing entity computer server, including memory and a computer processor programmed to:
(i) receive the electronic quote request from the risk relationship agency management system computer server,
(ii) responsive to the quote request, arrange to match the potential risk relationship entity with a selected one of a plurality of supplemental potential risk relationship providers, and
(iii) transmit an indication of the selected supplemental potential risk relationship provider to the risk relationship agency management system computer server.

4. The system of claim 3, wherein the potential risk relationship entity identifier is associated with one of: (i) an entity that has a pre-existing relationship with the risk relationship agent, and (ii) a new entity.

5. The system of claim 4, wherein the potential risk relationship entity identifier includes at least two of: (i) an entity name, (ii) an entity policy number, (iii) a communication address, (iv) a postal address, (v) an effective date, (vi) a geographic location, and (vii) a Federal Employer Identification Number (“FEIN”).

6. The system of claim 3, wherein the risk relationship agency management system computer server is further adapted to communicate with a front-end potential risk relationship entity device associated with at least one of: (i) a personal computer, (ii) a tablet computer, (iii) a smartphone, (iv) a television device, and (v) a gaming device.

7. The system of claim 3, wherein the entity description is associated with at least one of: (i) an industry classification, (ii) an industry classification code, and (iii) an industry classification description.

8. The system of claim 3, wherein the supplemental potential risk relationship comprises an excess and surplus insurance policy.

9. The system of claim 8, wherein the indications associated with potential risk relationship categories represent at least two of: (i) commercial insurance, (ii) property and liability insurance, (iii) workers' compensation insurance, and (iv) business automobile insurance.

10. The system of claim 9, wherein the risk relationship agency management system computer determines that the excess and surplus insurance policy can be offered to the potential risk relationship entity when at least one of indications associated with potential risk relationship categories is valid.

11. The system of claim 8, wherein the servicing entity computer server is further to programmed to generate a consolidated billing statement associated with the excess and surplus insurance policy and at least one other risk relationship category.

12. The system of claim 8, wherein the servicing entity computer server is further to programmed to automatically modify a payment arrangement with the excess and surplus insurance policy payment plan into a modified payment arrangement.

13. The system of claim 8, wherein the servicing entity computer server is further to programmed to perform a renewal process associated with a termination date of the excess and surplus insurance policy.

14. The system of claim 8, wherein the servicing entity computer server is further to programmed to create a consolidated commission statement.

15. The system of claim 8, wherein the service entity computer server is associated with at least one of: (i) a non-admitted broker, (ii) an alternate marketplace placement team, and (iii) a wholesaler.

16. The system of claim 3, wherein the risk relationship agency management system computer server automatically attaches supplemental application documentation to the electronic quote request.

17. The system of claim 16, wherein at least some of the data in the supplemental application documentation is automatically obtained from a third-party device associated with at least one of: (i) a customer relationship management platform, (ii) a governmental platform, (iii) a real estate platform, (iv) a credit score platform, (v) a search platform, (vi) a social media site, and (vii) an advertisement system.

18. A computerized method to facilitate supplemental risk relationships, comprising:
accessing, by a computer processor of a risk relationship agency management system computer server, a potential risk relationship data store including a plurality of electronic records each including a potential risk relationship entity identifier, a remote risk relationship agent device identifier, indications associated with potential risk relationship categories, and an entity description;
based on the indications associated with the potential risk relationship categories and the entity description, dynamically determining, by the computer processor of the risk relationship agency management system computer server, that a supplemental potential risk relationship can be offered to the potential risk relationship entity;
exchanging information via a distributed communication network with a remote risk relationship agent device associated with the remote risk relationship agent device identifier to arrange for a graphical request symbol to be displayed;
receiving from the remote risk relationship agent device an indication that the graphical request symbol has been selected;
responsive to the selection, automatically creating, by the computer processor of the risk relationship agency management system computer server, an electronic quote request that includes the potential risk relationship entity identifier, the remote risk relationship agent device identifier, and the entity description;
transmitting the electronic quote request to a servicing agency entity computer server;
responsive to the quote request, arranging, by a computer processor of the servicing agency entity computer server, to match the potential risk relationship entity with a selected one of a plurality of supplemental potential risk relationship providers; and
transmitting an indication of the selected supplemental potential risk relationship provider from the servicing agency entity computer server to the risk relationship agency management system computer server.

19. The method of claim 18, wherein the supplemental potential risk relationship comprises an excess and surplus insurance policy.

20. The method of claim 19, wherein the computer processor of the servicing entity computer server is further to: (i) automatically modify a payment arrangement with the excess and surplus insurance policy payment plan into a modified payment arrangement, (ii) perform a renewal process associated with a termination date of the excess and surplus insurance policy, and (iii) track insurance claim information associated with the excess and surplus insurance policy.
